(19) United States
(12) Patent Application Publication
(10) Pub. No.: US 2011/0196760 A1
(43) Pub. Date: Aug. 11, 2011

(54) Online Marketplace for Bartering and Trading Used and Surplus Items

(76) Inventors: Tyrone A. Howard, Phoenix, AZ (US); Tracee M. Howard, Phoenix, AZ (US)

(21) Appl. No.: 12/874,194

(22) Filed: Sep. 1, 2010

Related U.S. Application Data
(60) Provisional application No. 61/272,305, filed on Sep. 9, 2009.

(51) Int. Cl. G06Q 30/00

(52) U.S. Cl. 705/26.41

(57) ABSTRACT

An online computer system for bartering and trading used or surplus items stores information on used items and calculates a value for the items. The system processes a search requests for desired items and automatically notifies an item owner when a purchaser's search matches the owner's item available for sale. The system facilitates communications between the parties regarding a potential trade of the item and automatically notifies a third-party that can provide services to facilitate and support the trade. After the parties agree to a trade, the system processes a transaction for the item by transferring credit from the account of the purchaser to the account of the seller based on the calculated value of the seller's item. The purchaser's credits amount in the purchaser's account can be based on a valuation of his used items stored on the online computer system.

### RELATED APPLICATION

This patent application is based on and claims the benefit of U.S. Provisional Application No. 61/272,305 filed Sep. 9, 2009 and entitled “Surplus Portal with Ghostbox and Social Network Marketing Online Affiliate Model,” the disclosure of which is incorporated herein in its entirety by this reference.

### COPYRIGHT NOTIFICATION

Portions of this patent application include materials that are subject to copyright protection. The copyright owner has no objection to the facsimile reproduction by anyone of the patent document itself, or of the patent application as it appears in the files of the United States Patent and Trademark Office, but otherwise reserves all copyright rights whatsoever in such included copyrighted materials.

### BACKGROUND

The present invention relates generally to electronic commerce. More particularly, the invention relates to a method and online marketplace system for trading used and surplus items, which is particularly useful for the trade or barter of technology-related items.

The Internet is a global system of interconnected computer networks that use the standard Internet Protocol Suite (TCP/IP) to serve billions of users worldwide. It is a network of networks that consists of millions of private, public, academic, business, and government networks of local to global scope that are linked by a broad array of electronic and optical networking technologies. The Internet is also an extraordinary medium for electronic commerce platforms. Many such existing platforms operate as on-line retailers, as on-line auctions, or online classified advertising services that allow individuals to posting items for sale.

These platforms, however, do not provide an efficient a means for parties to exchange or barter for goods and services. Rather, they all rely on payment by debit or credit card or an online payment service such as the PayPal® payment service. For example, in the case of on-line retailers, a prospective buyer accesses the retailer's website, searches for primarily new items for sale and checks-out by providing currency in the form of a debit credit card or PayPal. Similarly, in order to participate in an auction, the buyer purchases “Bid Credits” with a credit/debit card or PayPal. If the bid wins the auction the item is sold and credits are deducted from the winner's account. With online classified advertisement and bulletin board services, such as the Craigslist® website provides, an item is sold when both parties agree to a selling price and the buyer provides currency in the form of C.O.D., credit/debit card or PayPal. In short, while these existing Internet platforms work well for certain products, they typically do not work for products or services that are to be exchanged or bartered. There is a need, therefore, for a new method and system to implement online bartering and exchange of goods and services.

A market for used and surplus software and other technology-related equipment is one that presents unique problems and that could benefit greatly from a suitable method and system for bartering and trade. Such items include, for example, personal computer software and hardware, televisions, video games, iPod® digital electronic devices, mobile telephones, PDA's and the like. Often times, such software and equipment goes to waste; it is buried in closets, destroyed or its value simply disappears (e.g., software on a destroyed computer) or becomes obsolete over time. At the same time, there are many people and institutions, such as educational institutions, that could benefit greatly from the remaining “secondary value” of such items. Currently, however, there are no platforms that can track and capture the “secondary value” of such technology-related equipment or that can provide for the online exchange of such equipment.

It is an object of the present invention, therefore, to provide a method and system that can provide a market for used and surplus equipment, such as hardware, televisions, video games, iPod® digital electronic devices, mobile telephones, PDA's, and the like.

It is another object of the present invention to provide such a method and system that allows users to search, barter for and trade such used or surplus items and related services.

Another object of the present invention is to provide such a method and system that allows users to track, manage, trade and donate such assets.

Still another object of the invention is to provide a method and system that can recover any original purchase or depreciated value in used or surplus items that otherwise would be lost.

It is another object of the invention to allow users to collect data on used and surplus items and to project future surplus product availability.

Another object of the present invention is to provide such a method and system that can be used by public, academic, and nonprofit entities.

Still another object of the present invention is to provide a method and system that can be used to form online social network communities for trading used and surplus assets.

Yet another object of the present invention is to provide a method and system that allows users to obtain support services to facilitate trades of used and surplus items.

Additional objects and advantages of the invention are set forth in the following description, and in part will be apparent from the description, or can be learned by practice or observation of the invention. The objects and advantages of the invention can be realized and obtained by means of the methods and apparatus pointed out in the appended claims.

### SUMMARY OF THE INVENTION

To achieve the foregoing objects, and in accordance with the purposes of the invention as embodied and broadly described in this document, there is provided a new method and system for the exchange and bartering of technology-related equipment and services.

According to one aspect of the invention, a method online trading of used or surplus items includes the steps of: using a computer system to prompt a first user of a plurality of users to upload to an online computer system product information regarding a used item; storing the uploaded, item in a database of used and surplus items; the first user to assign a trade level to the item, wherein the trade level determines at least in part whether the uploaded item is available for trade; calculating a value for the uploaded item based on information including one or more of the item type, the item brand, frequency of trades for like items, market demand for the item, survey information obtained from the plurality of users and retail pricing data for like items; storing a value based on the calculated value for the uploaded item; storing a credit amount for account of a second user; receiving a search request from the second user regarding a desired used item; in response to the second user's search request, performing a search of the database of used and surplus items; automatically notifying the second user if the first user's uploaded item matches the second user's search request and is available for trade (including sale, donation or recycling); facilitating communications between the first and second user regarding a potential trade of the item; automatically notifying a third-party that can provide services to support a trade of the item; and after receiving notice from the first user and the second user that they have agreed to a transaction for the item, processing the transaction. The processing of the transaction includes transferring a credit from the account of the second user to an account of the first user based on the calculated value of the uploaded item. The transferred credit is deducted from a credit amount stored in the account of the second user, which second user credit amount is based on a valuation of used items uploaded by the second user to the online computer system.

The method and system of the invention provides thereby captures secondary value of used or surplus items, such as computers, software, mobile phones, medial equipment and goods and other rapidly depreciating items, and facilitates the barter and trade of these items, thereby creating an online market for the secondary value of such items.

Through the exchange or bartering credit, businesses, government agencies and non-profit organizations can leverage values of what they submitted or what others have agreed to trade. Additionally, these credits can be purchased with actual dollars.

### BRIEF DESCRIPTION OF THE DRAWINGS

The accompanying drawings, which are incorporated in and constitute a part of the specification, illustrate the presently preferred methods and embodiments of the invention and, together with the general description given above and the detailed description of the preferred methods and embodiments given below, serve to explain the principles of the invention.

FIG. 1 is a simplified relational diagram depicting the business model and relationships between and among parties who can use and benefit from the method and system of the present invention.

FIG. 2 is a functional block diagram of a preferred computer system and a network for practicing the present invention.

FIG. 3 is a functional block diagram depicting the components of one embodiment of an online portal and various functions that can be performed using the portal according to the present invention.

FIG. 4 is a flow diagram depicting a process for valuing assets according to the present invention.

FIG. 5 is flow diagram illustrating an example of a fundamental transaction according to the invention, wherein the transaction involves an individual member purchasing computers from a trade group.

FIG. 6 shows an exemplary screen display of a home page of the website portal of FIG. 3.

FIG. 7 shows an exemplary screen display of a member profile page of the website portal of FIG. 3.

FIG. 8 shows an exemplary screen display of a website page of the website portal of FIG. 3, with which a user can add or manage his or her trading account, including his or her user profile and messaging setup.

FIG. 9 shows an exemplary screen display of a web page of the website portal of FIG. 3, with which a user can send and receive messages to other user's and view items stored in the user's inventory.

FIG. 10 shows an exemplary screen display of a web page of the website portal of FIG. 3, by which a user can assign a trade level to an asset in his or her inventory.

FIG. 11 shows an exemplary screen display of a web page of the website portal of FIG. 3, with which a user can search searching assets stored in the system that available for trade.

FIG. 12 illustrates an example of an asset search performed according to one aspect of the invention.

FIG. 13 shows an exemplary screen display of a web page of the website portal of FIG. 3 illustrating how a user can receive notifications of a proposed transaction and can negotiate the transaction or accept, decline, delay, or request insurance for the transaction.

FIG. 14 shows an exemplary screen display of a web page with which a user can send and receive messages to other users and illustrating one user interacting with another to discuss items that are available within their inventory for trade.

FIG. 15 illustrates a process performed according to the invention to conclude one example of a transaction.

FIG. 16 shows an exemplary screen display of a web page with which a user can send and receive messages to other user's and view items stored in the user's inventory and illustrating a notice to a user indicating that a transaction has been accepted by another user and a service provider.

FIG. 17 is an example of a pop-up window that can appear to a user during the transaction process and by which a service provide offers more specifics about the services they can provide to support the transaction.

FIG. 18 illustrates a process by which the parties complete a transaction using their unique transaction numbers, including confirmation by a service provider.

FIG. 19 shows an exemplary screen display of web page illustrating other services that a user can access via the portal system to support a transaction.

FIG. 20 illustrates an example of a screen display of a web page of a transaction being processed by the portal system of FIG. 3.

FIG. 21 depicts an example of relationships between one member and many others as it pertains to trade groups that can be formed according to one aspect of the invention.

FIG. 22 shows an example of a trade group of six individuals that will all receive financial benefit when an asset is sold from their group according to one aspect of the invention.

FIG. 23 depicts an example of a national search of assets that can be performed using the portal of FIG. 3.

FIG. 24 illustrates the components of one embodiment of a portable device that can be used to upload software from a personal computer the portal system of FIG. 3.

FIG. 25 shows the portable device of FIG. 24 in use.

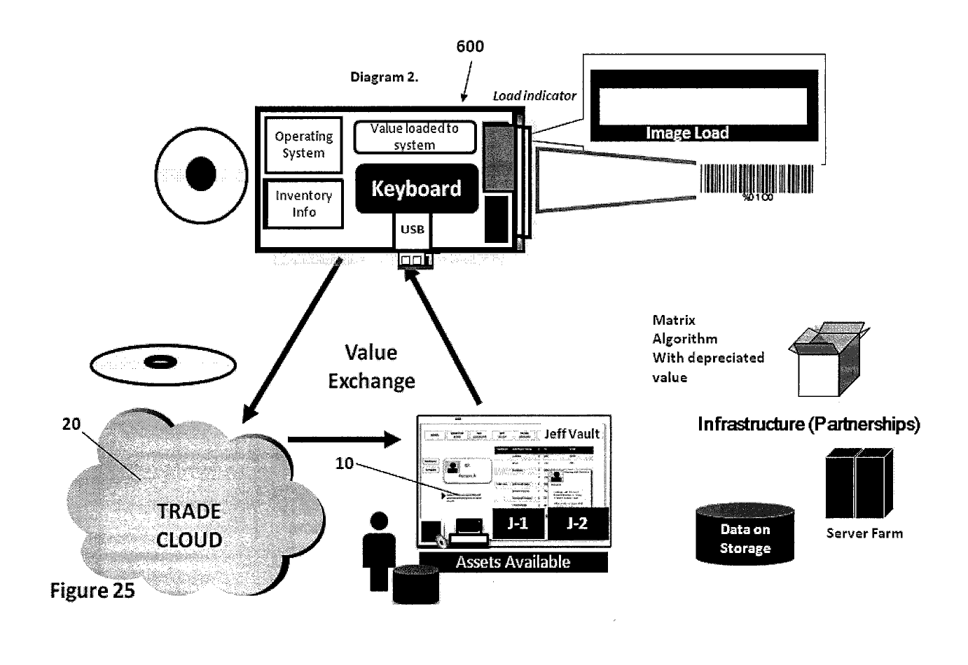

### DESCRIPTION

Reference will now be made in more detail to presently preferred embodiments and methods of the invention. While the invention is described more fully with reference to these examples, the invention in its broader aspects is not limited to the specific details, representative devices, and illustrative examples shown and described. Rather, the description that follows is to be understood as a broad, teaching disclosure directed to persons of ordinary skill in the appropriate arts, and not as limiting upon the invention.

The method and system of the present invention focuses on the secondary value of used or surplus items—such as software, hardware, video games, iPod® digital devices, cell phones, PDA's and medical equipment and goods—and allows owners of such assets to inventory those items and track, value, trade, recycle, donate or “cash out” the value of their inventory. The method and system of the invention can be used to change how consumers and organizations track and monitor used and surplus assets. It can serve as a vehicle for individuals and organizations to communicate current and future technology needs in a trusted social computer network setting. The method and system of the invention thereby provide a marketplace for secondary technology value that would have otherwise gone unrecognized by the owner.

The invention can provide numerous benefits and opportunities to its registered users. Among these benefits, it provides to a user the ability to:
trade assets with other users based on the system's valuation of those assets;
exchange assets for credits based on that valuation;
donate assets;
pool assets with other users by forming trade groups, such as other users who are selling like goods or services;
recycle assets for scrap; and
obtain or provide support services for the foregoing, such as computer repair services, storage, delivery services, moving services, and installation and set-up of purchased items.

Using the method and system of the invention, one can retain historical information on property, online searching and company notification of what is about to become surplus, information on where the surplus is located and what is the perceived value (based on an established algorithm). By valuing used and surplus items, the invention provides a form of a national or international barter currency (credit). This form of currency can encourage trade at four levels: Local, State, National, and International with the goal of mutual benefit between parties which would not otherwise have been realized if the property had gone unused or destroyed or was sent to a dump.

Through the bartering credit, individuals, businesses, government and non-profit organizations can recover value for such items. Additionally, credits can be purchased with traditional currency. For example, a small company could take $2000 that it can afford to spend on one computer and purchase 4 to 5 computers. Using the portal system, individual members and organizations can redistribute their barter credits to others users who are in need as well as to other programs for profit or non profit. Users can also donate their old items of equipment and their barter credits to other users, such as non-profit organizations.

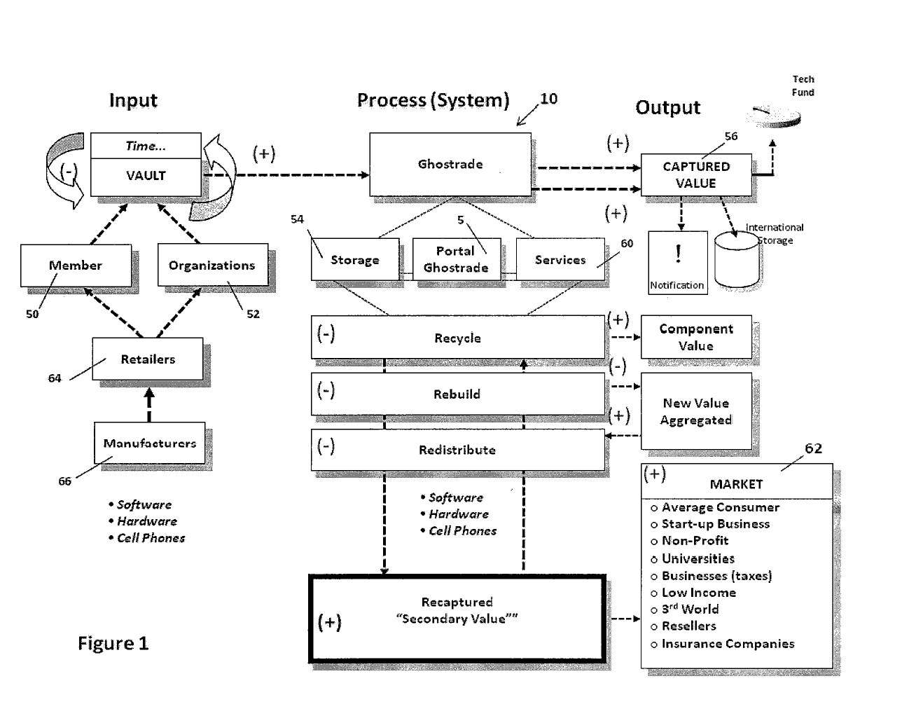

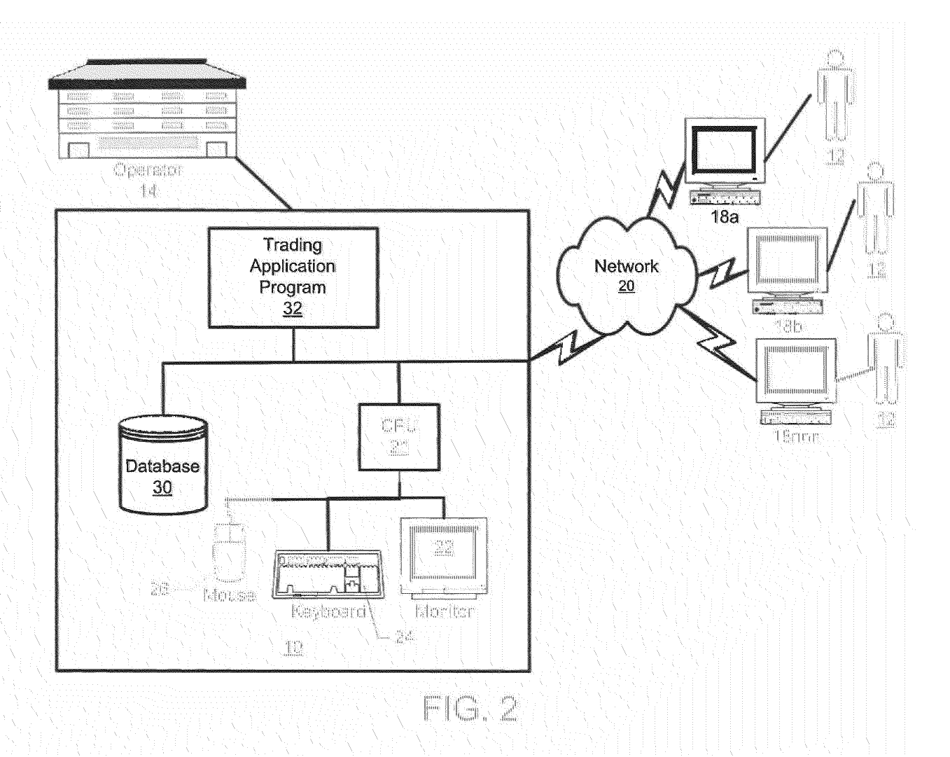

FIG. 1 illustrates the business model and relationships between and among parties who can use and benefit from the method and system of the present invention. FIG. 2 illustrates a preferred computer network system for providing practicing present invention. The system includes portal computer system 10 that stores and processes information regarding used and surplus items and trades of those items, as described below. The portal computer system 10 is operated by a portal operator 14. Users 12 can access the computer system 10 via user computers 18a, 18b, 18nnn, which are coupled to the computer system 10 via a computer network 20, such as the Internet.

Referring to FIGS. 1 and 2, users 12 of the portal system 10 can be registered individual members 50 or organizations 52. With the portal system 10, users can upload and store information regarding items in their inventory that they may wish to make available for trade. The portal system 10 can use this information to calculate and assign values 56 to the inventory items. After capturing this “secondary” value 56, the system enables users to trade inventory items 58 as well services 60 related to those trades, thereby creating a market consumers and businesses seeking to purchase or sell such items. Manufacturers 64 and retailers 66 also can benefit from the method and system of the invention by utilizing it to advertise newer or replacement items to members and organizations that trade used or surplus items via the system.

### Portal Computer System

Referring again to FIG. 2, the portal computer system 10 includes a central processing unit (CPU) 21 for processing data and program instructions. The computer system 10 also includes input and output devices, as is well known in the art. For example, it preferably includes a display screen or monitor 22, a keyboard 24, a mouse 26, a printer (not shown), etc. The portal computer system 10 further includes data storage and memory devices, as are known in the art, for storing a database 30. The database 30 is used to store data used by the portal computer system 10, as described below. Preferably, the database 30 is a relational database, as is well known in the art. A trading application program 32 is operable with the database to provide the functionality described below.

The portal computer system 10 is connected to the network 20, which serves as a communications medium for user computers 18a, 18b, 18nnn (where nnn refers to any number of users) and the computer system 10. In a preferred embodiment of the invention, the network 20 comprises the Internet. The Internet is a global network of computers. One popular part of the Internet is the World Wide Web, or the “Web.” The World Wide Web includes computers that display graphical and textual information. A “website” is defined by an Internet address that has an associated electronic page, often called a “home page.” Generally, a home page is an electronic document that organizes the presentation of text, graphical images, audio and video into a desired display. Upon reading this specification, those skilled in the art will now understand that, under appropriate circumstances, considering issues such as developments in computer hardware, software and connectivity, etc., other network configurations and devices also may suffice, such as for example, PDAs connected via a wireless network, etc.

### Portal Components and Functions

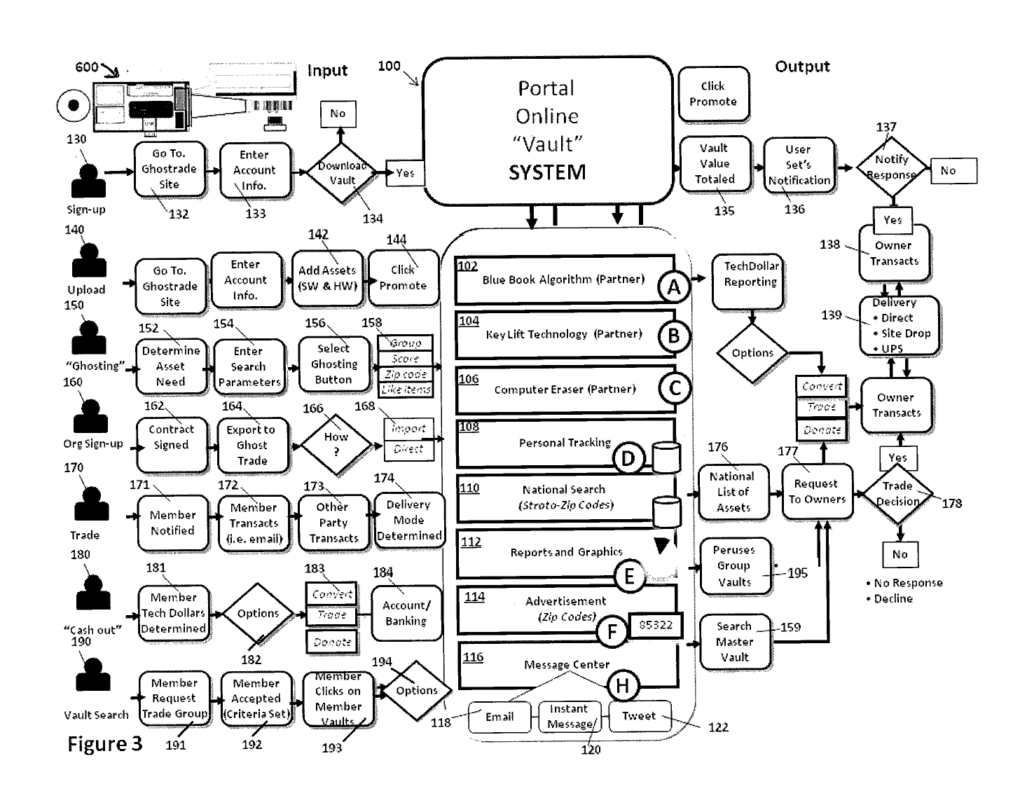

FIG. 3 illustrates the functional components of one embodiment of an online portal system 10 and various functions that can be performed using the portal system 10 according to the present invention. Referring to that figure, the portal system functional components include: a valuation algorithm component 102, a key lift technology component 104, a computer eraser component 106, a members inventory component 108, a search component 110, a reports and graphics component 112, an advertisement component 114 and a message center component 116.

The valuation component 102 utilizes a valuation algorithm to place values on assets that are uploaded, tracked, donated and purchased in portal system 10. One presently preferred valuation component is described in more detail below.

The key lift technology component 104 provides access to tools for accessing the registry of a computer and identifying software programs that have been loaded by way of a license keys (software IDs), then copying the keys and moving them into a user's account (vault) on the portal system 10 to be used for tracking and commerce if desired. One suitable software tool for capturing such license keys is Magical Jelly Bean Keyfinder, which is a utility that can retrieve software product keys used to install Windows from a computer registry, and which also has a community-updated configuration file that can retrieve product keys for many other applications. More information on this utility can be found at http://www.magicaljellybean.com/keyfinder. With such a tool, a user can read a computer registry, identify and capture the identification keys and upload those keys into the user's individual vault to make the software licenses available for other users by downloading the ID and a link or executable code for installation on their computer. Such a user can download the executable code, and when prompted for the software ID, can enter the key that they have in their vault. Once software is registered, the keys can be tied to an account so that only one person can own that key (license).

### Computer Cleaning and Optimization

The computer eraser component 106 provides access to tools for erasing software and personal information from devices before trading them via the portal system 10. Two examples of suitable software tool for erasing information from computers are the System Mechanic® and DriveScrubber® products marketed by iolo Technologies, LLC of Los Angeles, Calif. Portable storage media, such as CDs, can be provided with erasure software to perform this function. Additionally, users can send items to a third party service provider that is certified to wipe such information from computers. One third-party source for such services is Unicor, LLC of Albuquerque, N. Mex. Other examples tools that can be made available to users of the portal system 10 (e.g, through third-party partnerships) can include, for example, tools of optimizing personal computer performance, which are well known, and tools for transferring content stored on mobile telephones, such as those provided by Cellebrite Mobile Synchronization, Ltd. Some third-party services may be provided to free or at a discount price to portal members.

The members inventory component 108 stores the assets (including services), that are loaded online to be tracked and valued over time This component can be used to categorize assets (or promote them to various levels ranging from “Private” all the way to “Public” view), as described in more detail below. The database 30 stores each asset inventory of each registered user (i.e., member) of the system. The member can use the system to upload, track, and manage their inventory (sometimes referred to as their “vault”). Members can access the assets in their own vault, but cannot necessarily access the assets within another member's vault. A member can make an asset available to others for search and transactions, however, by assigning an appropriate trade level to the asset. In one preferred embodiment, these levels include: Public Vault (Open to everyone for sell across the Internet); Strata (Vault access restricted to the locations determined: local, state, county, federal, countries); Trade Friends Vault; and Private Vault.

The search component 110 provides the ability to query asset information stored in the portal system database 30 in order to find assets that are available for trade based on search criteria, such as trade levels, zip codes, specifications, etc. The search component also includes the ability to search the Internet for information, assets and equipment.

The reports and graphics component 112 provides tools for generating the various reports and graphics depicting information such as types of items traded, value, ownership, and various other data that can be presented graphically to users.

The advertisement component 114 allows providing targeted advertisements or promotions to users. Such promotions can include, for example, providing manufacturer or retailer discounts to new asset owners to encourage them to buy the newer model of an asset that has been uploaded to the system.

The message center component 116 includes functionality to allow users to communicate with each other regarding their interest in trading items and to provide notifications of trading opportunities. Preferably, this communication functionality includes email 118, instant messaging 120 and integration with social networking applications 122, such as Twitter, LinkedIn, FaceBook.

### Valuation Component and Algorithm

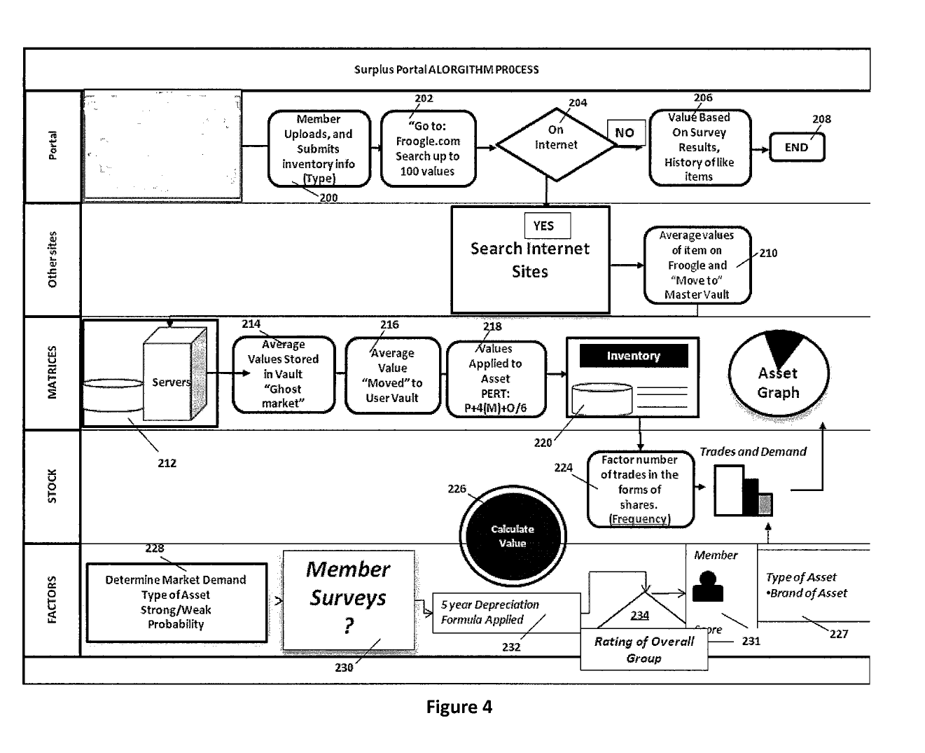

As discussed above, according to one aspect of the invention, the portal system includes a valuation component 102 that implements a process for calculating values of assets. FIG. 4 is a flow diagram depicting one example of a process for doing so. The system 10 continuously places values on assets stored in inventory (vaults) and adjusts those values based data collected from searches of outside databases for values of relevant items. Using this data, the system calculates asset value using a statistical averaging algorithm and stores that value at a system level. The system also stores the value of the asset in the account of the user that owns the asset, thereby creating opportunity for commerce and donations and providing graphical and table view of assets and values. Values can be calculated and dynamically adjusted over time based on factors that can include:
Type and/or Brand of Asset 227—for example, some types of assets will depreciate more slowly than others, and some brands of assets will depreciate more slowly than others based on quality and cost; Frequency of trades—frequent trading can slow depreciation of an asset;
Market demand for items like the subject item 228, as determined by trade activity on the portal system—for example, an asset that trades on average 3 times within 5 years would be in high demand and therefore have a longer life and slower depreciation;
Member surveys 230 (random or otherwise) by which system users provide estimates of the value of particular items;
The member offering the asset 231—based on the offering member's account trade score or industry;
Retail price and depreciation calculations 232;
The trade group offering the asset 234—if a trade group historically is top performing, then items affiliated with that group will have a higher value (premium).
Price Floor Drops and Increases—Statistical drops and increases in values on products can stimulate or slow movement of assets, and large groups of users may vote to drop or increase the floor value of an asset.
Whether an item is insured by the user offering the item.

Still referring to FIG. 4, after a user 12 creates an account (vault), he or she begins the valuation process by uploading to the portal system 10 information about the asset as previously described, including an estimate of the value of the item (step 200). The system 10 uses this information to perform an online query for value information for similar items listed in one or more pricing engines that provide pricing information for new and used products (steps 202). One such pricing engine is the Froogle price comparison service provided by Google, Inc. of Mountain View, Calif. If price information is available from the pricing engine (step 204), the portal system 10 averages the values resulting from this search and stores that average value for at the system level (steps 210). If value information is not available from the pricing engine, the portal system 10 computes an initial value based on results of member survey and the value history of like items traded on via the portal system (step 206).

Pricing data can be supplemented by information from third party providers of such information for specific types of items or by consumer price index information (step 212), which also is stored at the system level. This data also can be used to calculate an average value for an item, which can then be stored at the system level (step 214) as well as at the user account level (step 216). According to a presently preferred method, this averaged data is used to calculate a value for the user's asset (step 218) by using a normal distribution curve and applying the following formula to calculate a price that most persons would pay for the item:

Asset value=(pessimistic value+4(most likely value)+optimistic value)÷6

As discussed above, an item's value can be shaped and adjusted by various factors, including member surveys. Members can be provided opportunities to receive benefits (e.g, an increased member trade score), by completing brief online survey(s) on the value of asset(s). Preferably, members must estimate the value within a defined range (e.g., plus or minus 15 percent of a calculated average value) to receive the benefit. This member survey data can be pooled and used in an averaging calculation, thereby impacting value of asset within the system.

According to another valuation aspect of the invention, the assigned value of assets can be calculated to take into account a discount for the fact that the item is used (step 232). For example, the valuation calculation can include a 20% discount of an item from the new price of a comparable asset based to reflect the fact that soon as a new item is purchased, its market value drops (similar to automobiles).

Asset value can be depreciated based on the passage of time. For example, asset value can be depreciated over a 5-8 year period. According to one method, if the asset value falls to 20% or less of the item's original value, the system categorizes the item as “scrap.” If an item is categorized within the system as scrap, it still can be sold or traded for the value of its parts or to be refurbished or recycled.

### Portable Hybrid Device

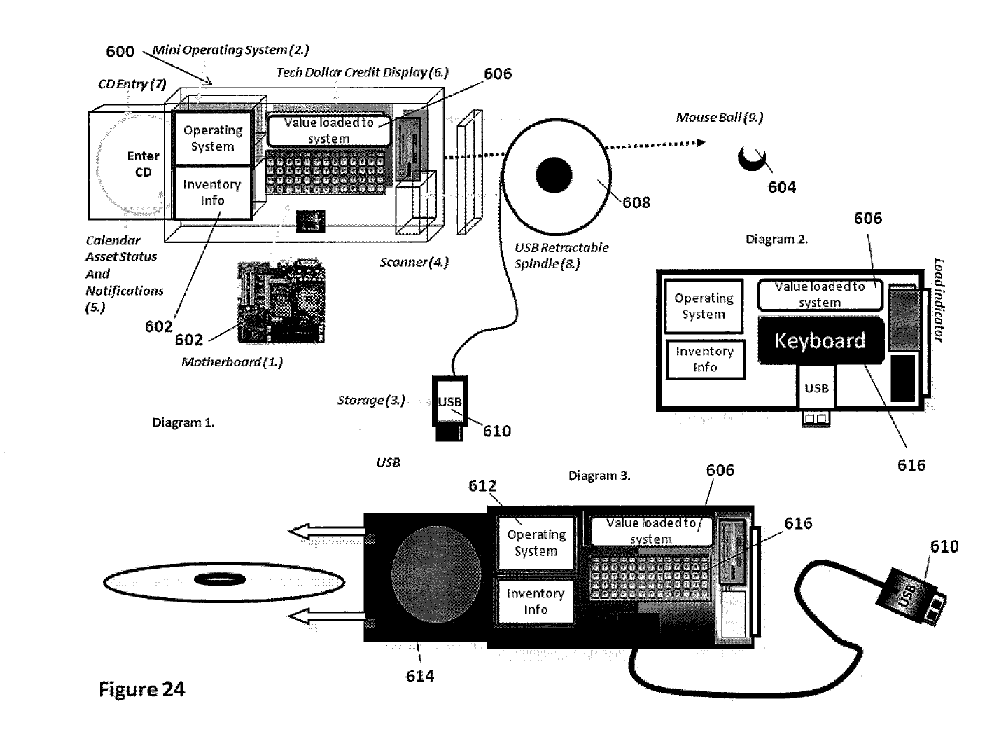

In one embodiment of the invention, a portable hybrid device 600 can be used to upload software to the portal system 10 and manage that software. Referring to FIG. 24, one presently preferred one embodiment of the portable device 600 includes: a frame; a motherboard 602 having a processor, memory for data storage and wireless communications capability; an integrated mouse roller ball 604 for navigation and clicking; a display for showing a user's value of assets and inventory stored on the portal system 10; an integrated bar code and RFID scanner 606; a spooled cable 608 with a USB connector 610; a DVD tray 614; a miniature display screen 612 for displaying the user's calendar, asset status and system notifications; and a miniature keyboard 616.

Preferably, the device will be about the size of current PDA devices. The USB connector 610 can plug into computers, TVs or similar electronic devices having a USB port (i.e., items to be uploaded to the portal system 10) and can use the display of that item as a “dumb terminal” (screen only). With the scanner, the device 600 can be used to scan hardware and store software in a passive mode until it is plugged into a dumb terminal. The device 600 can syncs through wireless communications to the portal system 10, allowing the user to upload, inventory, track, receive, update, transfer, and monitor items stored on the system 10.

In this configuration, the device 600 can be used as a standalone device and/or as part of the overall portal system 10. As shown in FIG. 24, it can integrate with the portal system 10 and can add an item to the user's inventory based on the portal valuation algorithm (similar to Blackberry integration with other social network tools).

### Using the System

Referring again to FIG. 3, a user of the portal system 10 can perform the following functions: sign-up (step 130); uploading of assets (step 140); searching available information that has been uploaded to the system regarding assets that are available for purchase, trade, donation or service (i.e., “ghosting”) (step 150); organization sign-up (step 160); trading of assets (step 170); cashing-out (step 180); and vault searching (step 190).

### Sign-Up

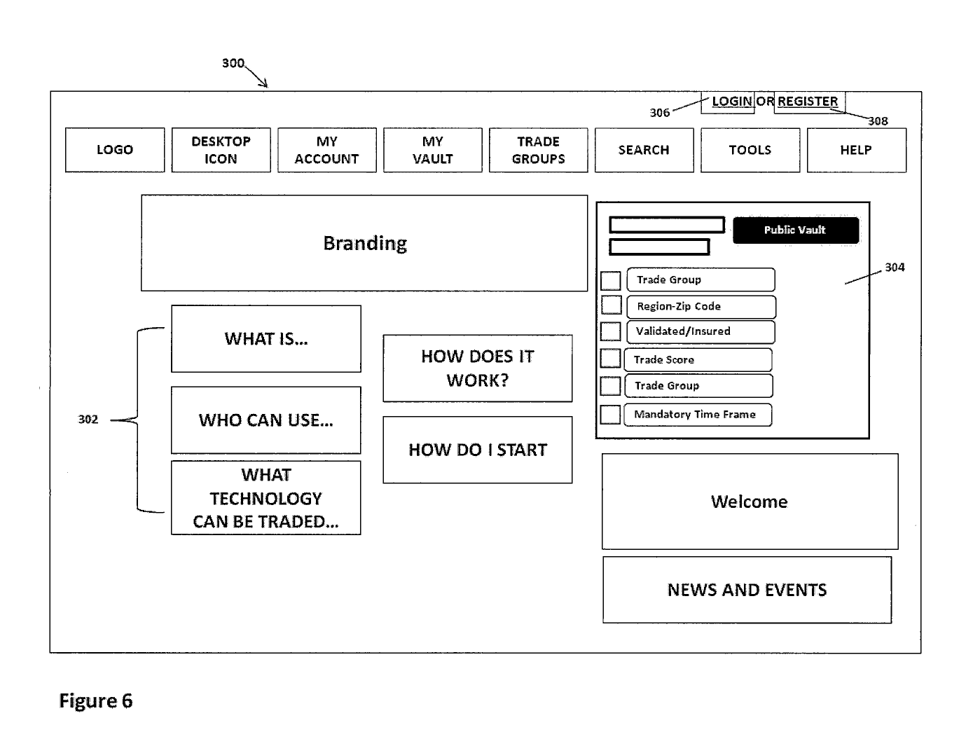

To begin the sign-up process 130, a new user must access the portal system home page (step 132). A user 12 can do so by going online at a remote computer 18, and accessing the website of the portal system 10 via the Internet. As shown in FIG. 6, this will take the user to a system home page 300 that is served by the portal system 10 to the browser of the user computer 18. Preferably, the home page 300 displays an informational section 302 that provides basic information regarding how to use the website and the type of items that can be traded. The home page 300 also includes a login link 306 and a registration link 308. In one preferred embodiment, the home page 300 includes a visitor search section 304, which a visitor to the website can use to make a limited number of asset searches before signing up as a member. Other than these user searches to use the system, a user must first register as a member and login to the system.

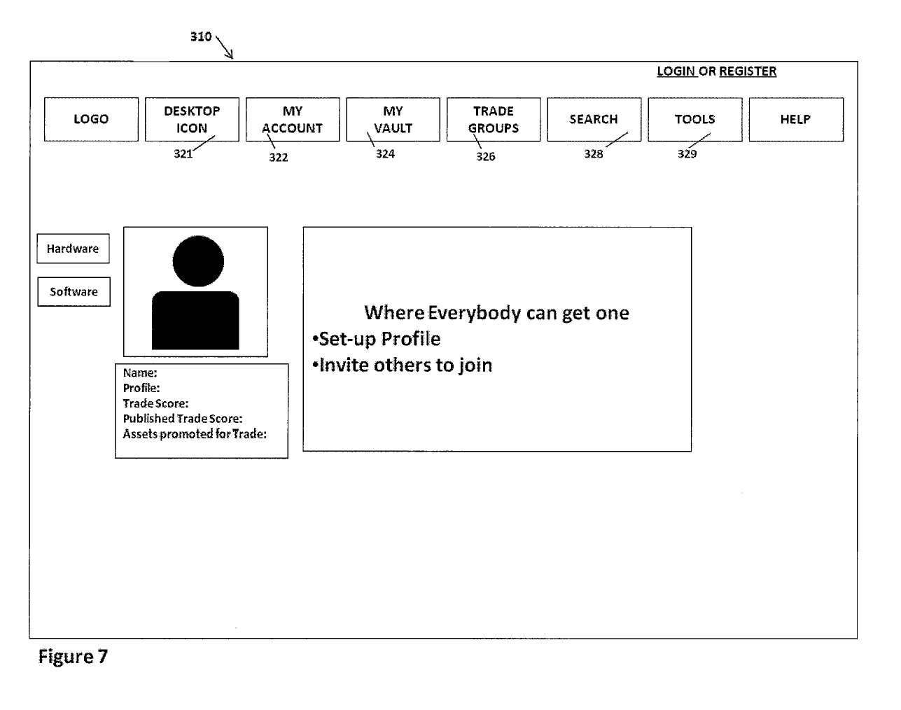

A user creates his or her account by providing certain basic information including, for example, full name, post office address, and telephone and e-contact information (step 133). After a user 12 has created an account, he or she can login (sign-in?) to the portal system 10. Upon sign-in, the website will system will display the user's member profile page 310, such as the example shown in FIG. 7. As the user navigates the website, the portal system displays a menu including a My Desktop button 321, a My Account button 322, a My Vault button 324, a Trade Groups button 326, a Search button 328, and a Tools button 329.

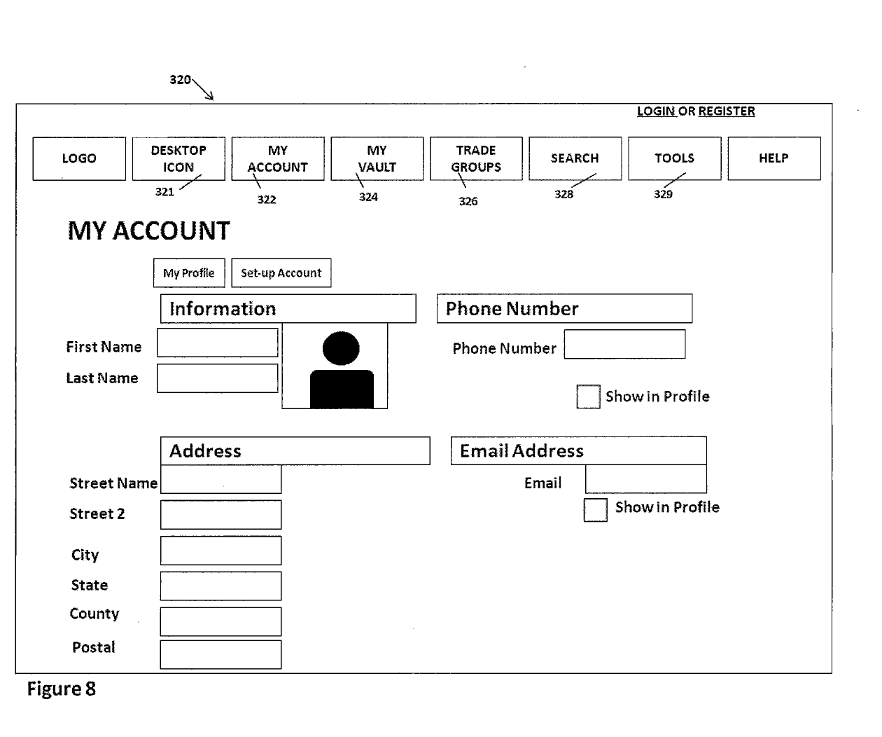

By clicking on the My Account button 322, the user can go to his/her account page 320, as example of which is shown in FIG. 8. Here, the user can add or manage his/her account, including user profile and messaging setup.

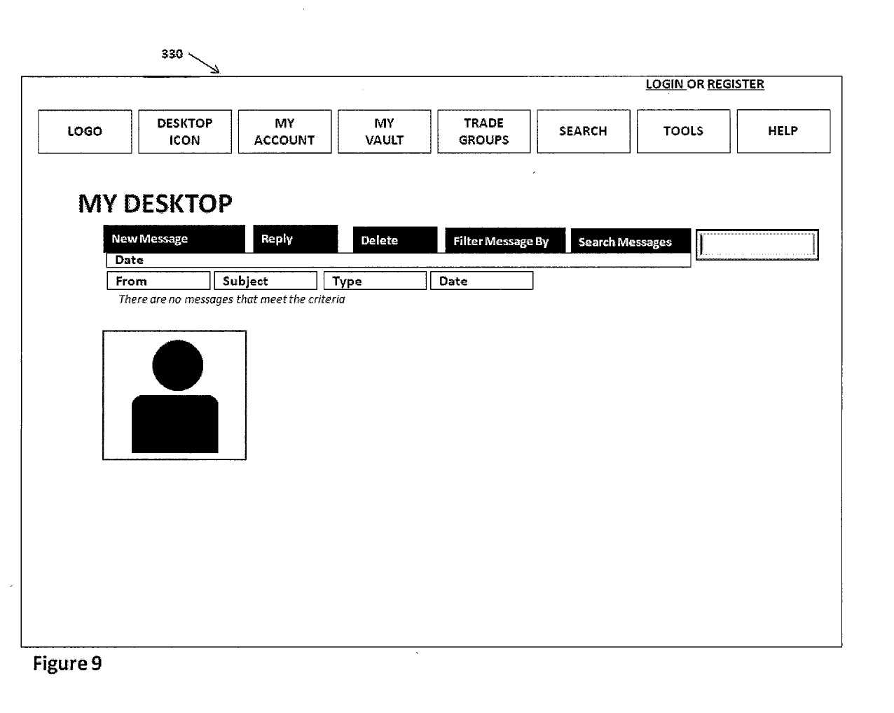

By clicking on the My Desktop button 321, the user can go to his/her desktop page 330, as example of which is shown in FIG. 9. Here, the user can send and receive messages and view items stored in his/her account.

By clicking on the Tools button 329, the user can go to a web page that allows the user download tracking and inventory value from the system, and provides access to tools described above, such as for capturing software keys, cleaning software from a device, and optimizing computer performance.

### Uploading Assets

Referring again to FIG. 3, a user can begin the upload process (step 140) to add hardware or software assets to his or hear account (vault) (step 142) by entering product identification information requested by the system, which can include for example, product ID, serial numbers, manufacturer identification, RFID, and the like. After an item is uploaded to the system, the user can promote the item for trade by setting a trade level for the time, which defines which other users can have access to the item (step 144).

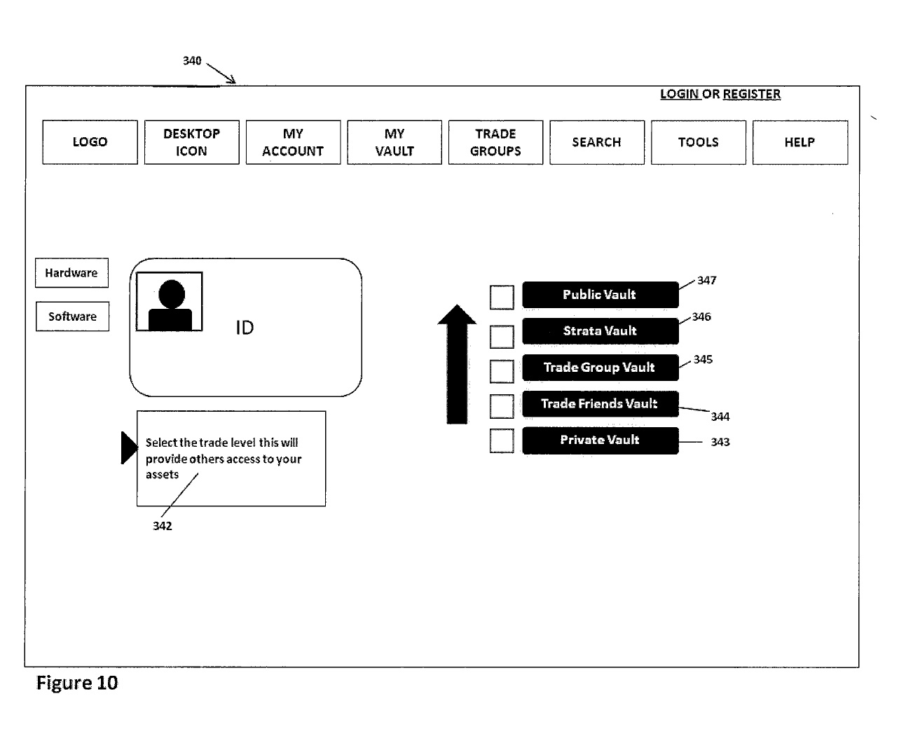

FIG. 10 shows one exemplary member web page 340 with a Select Trade Level button 342 displayed for this purpose. After the user clicks on the Select Trade Level button 342, the web page 340 displays check boxes 343-347 for assigning trade levels. According to one embodiment of the invention, these trade levels include Private 343, Trade Friends 344, Trade Group(s) 345, Strata 346 and Public 347. An asset assigned the Private level can be viewed only by the owner of the asset. An asset assigned the Trade Friends level can be viewed by users who are associated as friends. An asset assigned the Trade Group(s) level can be viewed only by members of the associated trade group(s). An asset assigned the Strata level can be viewed by users within a specific zip code or geographic region. An asset assigned the Public trade level is viewable and available for sale to everyone across the Internet.

After assets are uploaded to a user's inventory (vault) and are valued, their value can be totaled (step 135). An item stored in inventory, can be an “asset” or a “technical artifact.” An asset is any good or service that has value and has not depreciated to “scrap level.” A technical artifact is an item has no depreciated to or is otherwise at the point of having no operating value. Technical artifacts may be used for scrap or for refurbishing, rebuilding or recycling of component (e.g, gold, silver, copper etc).

In the embodiment of FIG. 10, a hardware button allows the user to directly access information on hardware items in their inventory, and a software button allows the user to directly access information in software items in their inventory.

### Searching for Available Asset

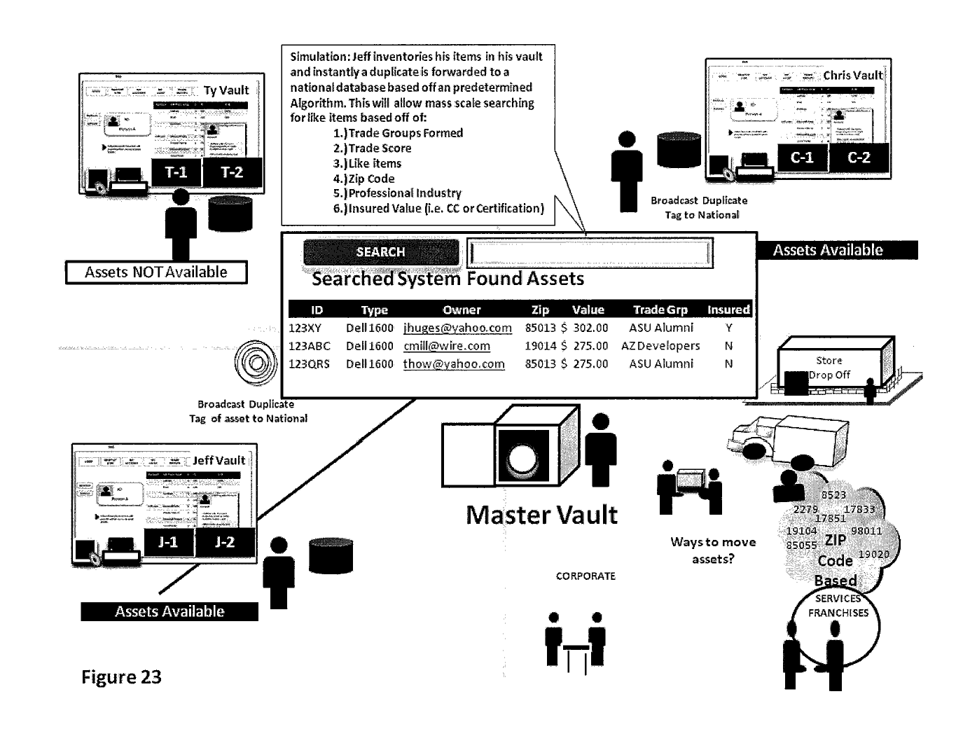

Referring again to FIG. 3, a user can begin the process of searching for assets that have been uploaded to the system and are available for purchase, trade, donation or service (step 150). After a user determines his or her asset needs (step 152), he can enter search parameters (step 154) and initiate a search of available assets (step 156). Searches can be conducted based on various criteria, including by trade group, trade score of the member offering an asset, zip code or geographic area and asset type (step 158). FIG. 23 depicts an example of a national search of assets viewed across the US and the various modes of delivery in the lower right corner.

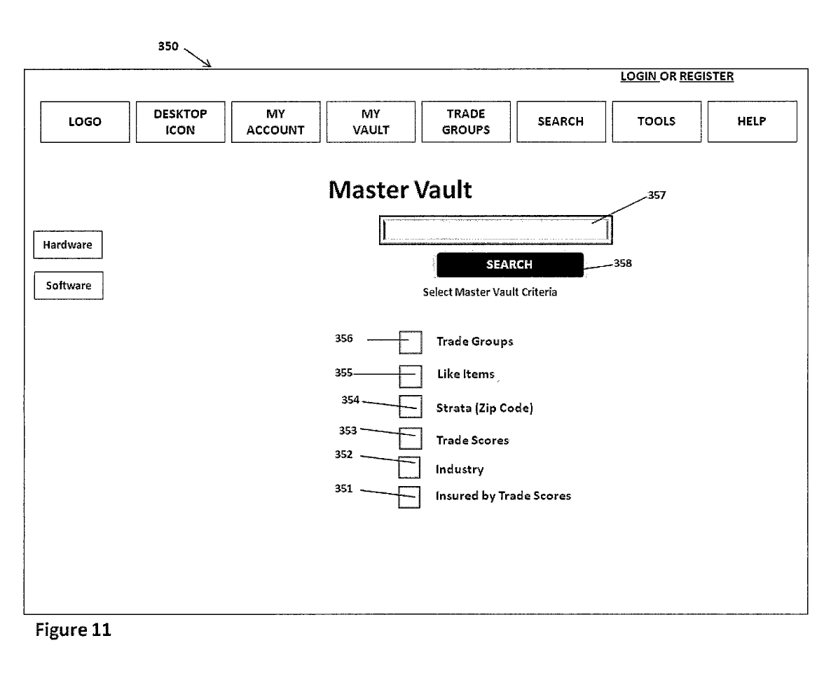

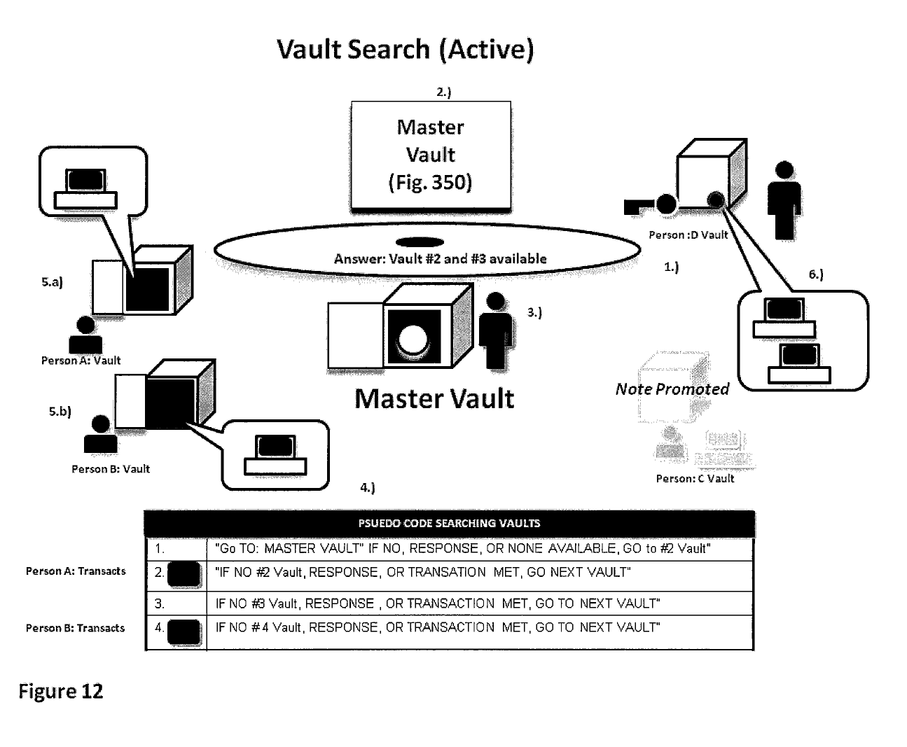

Referring to FIG. 8, to conduct a search, the user clicks on the menu Search button 328. FIG. 11 shows one exemplary member web page 350 entering search parameters (step 154). The web page 350 includes a text field 357 for entering a description of the item sought as well as check boxes for selecting additional criteria including Trade Group 356, Like Items 357, Strata (Zip Code) 354, Industry 352 and Insured by Credit Card 351. After the desired criteria are selected, the user can initiate a search of the assets available for trade by clicking on the Search button 358. In response, the system will return search results based on the selected criteria. FIG. 12 depicts pseudo code for implementing an example of one such search.

### Organizational Sign-Up

Referring again to FIG. 3, an organization also can sign up on the system in a manner similar to an individual (step 160). Individual members can be associated with an organization. The system can provide the ability for organizations to automatically upload information regarding their assets by importing it to the portal system (step 166).

### Trading

According to one aspect of the invention, users of the system can engage in transactions of items stored in the system by entering into online agreements to sell, trade, purchase, or donate those items. These transactions are based on the value assigned to each asset in accordance with the valuation algorithm previously described.

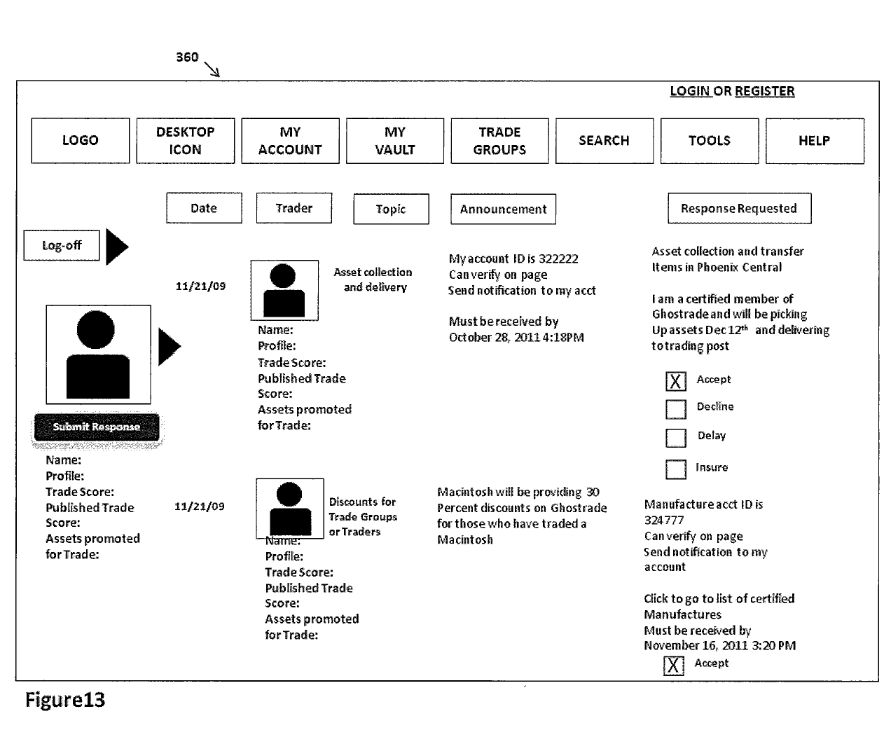

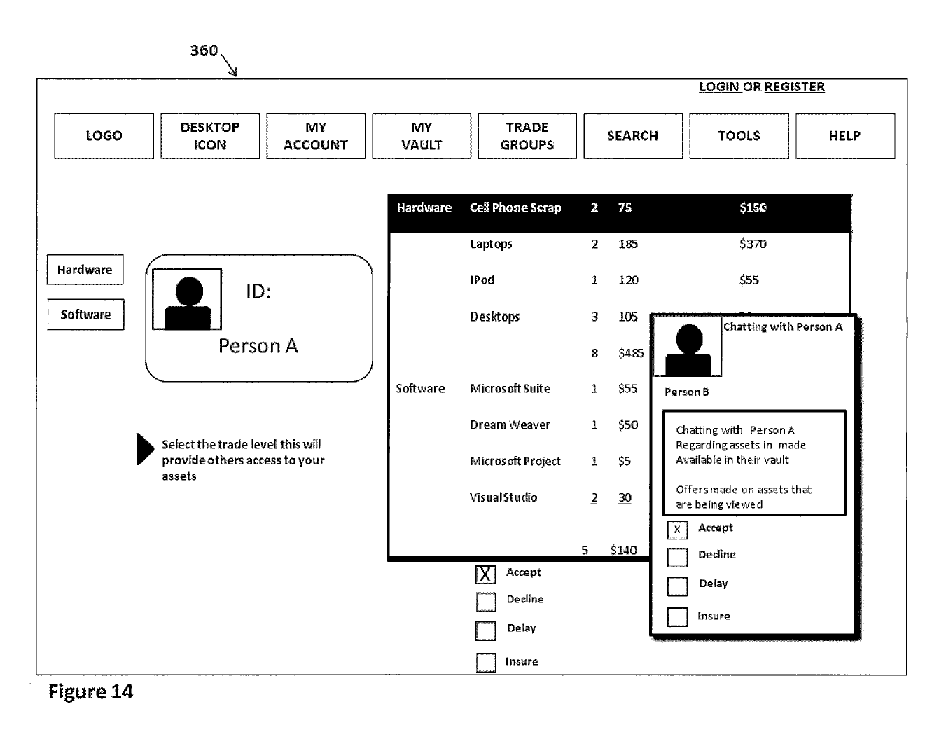

Referring again to FIG. 3, a user can initiate a trade (step 170), which causes the system to send notification of the user's interest via the system messaging function to other user's who have available assets in their inventory (step 171). The parties can then correspond regarding the trade via the system messaging function (steps 172-173). When the system notifies a user of a potential transaction (step 137), that user can respond that they wish to complete a transaction (step 138). As part of the transaction process, the parties agree to a mode for delivery (steps 139, 174). FIG. 13 depicts one exemplary web page 350 illustrating how a user can receive notifications of a proposed transaction and can negotiate the transaction or accept, decline, delay, or request insurance for the transaction, as well as illustrating related market transactions and opportunities occurring within a given time frame. FIG. 14 shows an example of a web page 360 illustrating a user interacting with another to discuss items that are available within their vault.

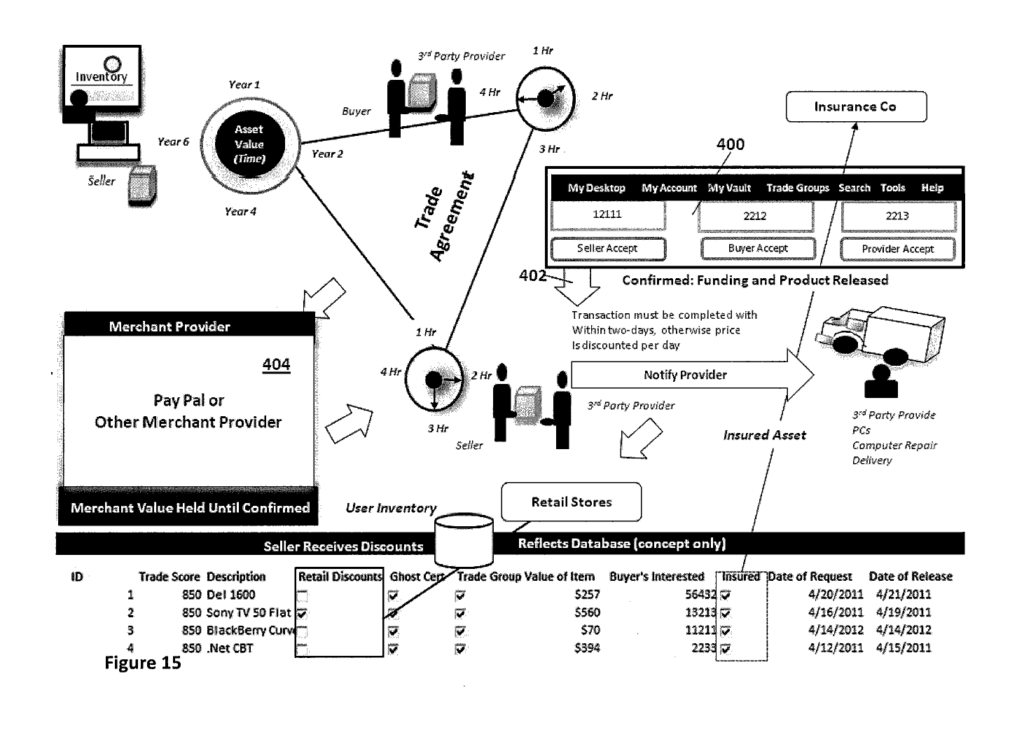

FIG. 15 illustrates the process performed by the system to conclude one example of a transaction. When a party accepts a proposed transaction, the system can notify a third-party service provider (step 402), such as a provider who can ship the asset from the seller to the buyer. Such notices can be sent to providers based on specific criteria, such as zip code, score, insurance and longevity in business. Preferably, the system sends the seller options to select from multiple suitable service providers. To conclude the transaction, the system generates a hidden transaction number for each party, including any selected third-party service provider (step 400). Payment for the transaction is held in abeyance (step 404) until the parties indicate their acceptance to the transaction by entering their hidden transaction numbers (a form of signing the transaction agreement). As this example illustrates, the portal system 10 can create triangular relationship among a buyer, a seller and a service provider. In this way, the system matches needs between the buyer and seller, while at the same time providing and opportunities for one or more third party service providers to facilitate the exchange between the buyer and seller.

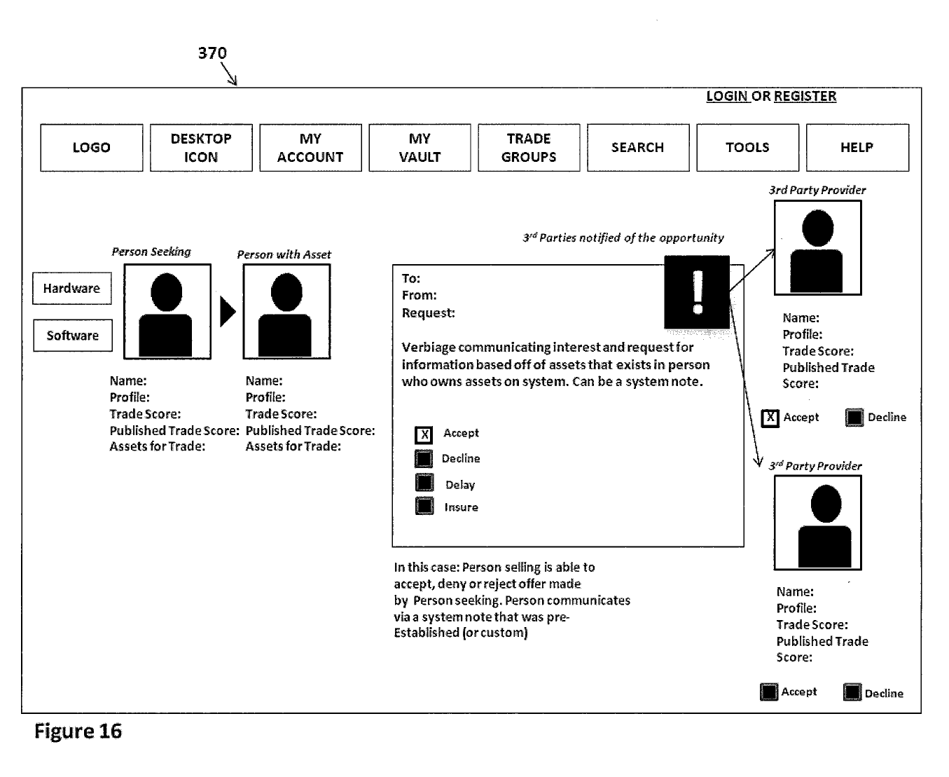

FIG. 16 shows an example of a web page 370 illustrating a notice to a user indicating that a transaction has been accepted by another user and a service provider.

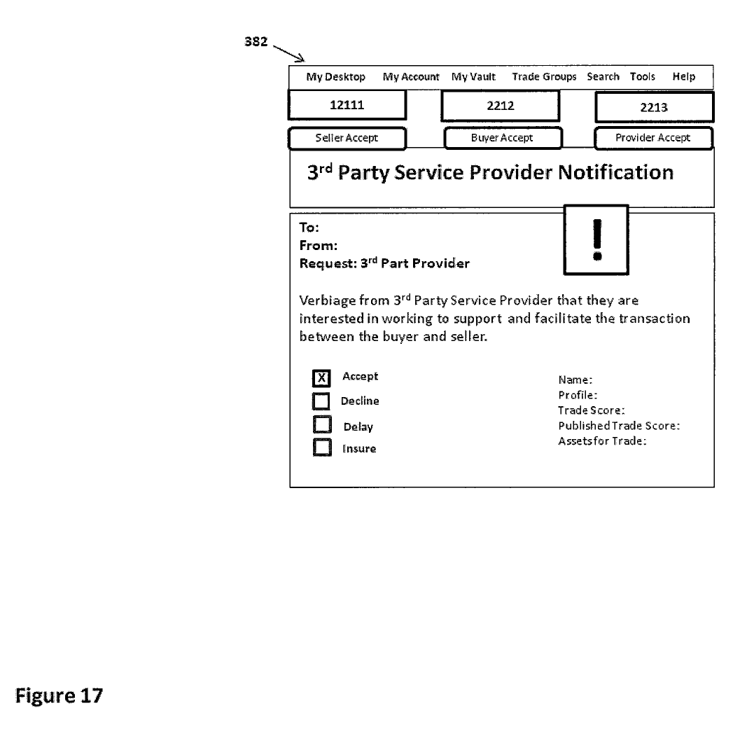

FIG. 17 is an example of a pop-up window 382 that can appear to a user during the transaction process and by which a service provide offers more specifics about the services they can provide to support the transaction.

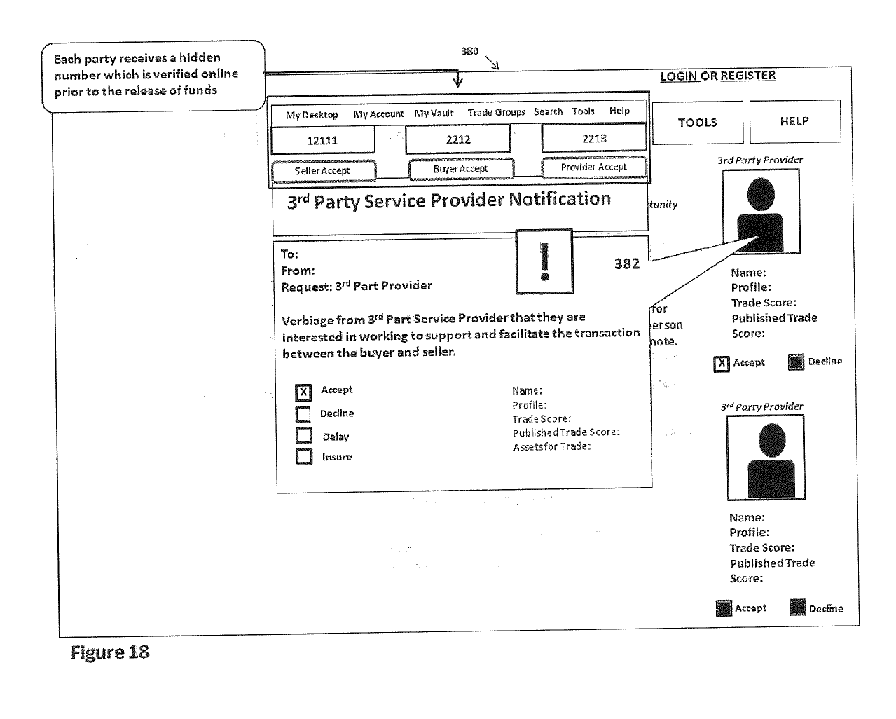

FIG. 18 illustrates a process by which the parties complete a transaction using their unique transaction numbers, including confirmation by a service provider.

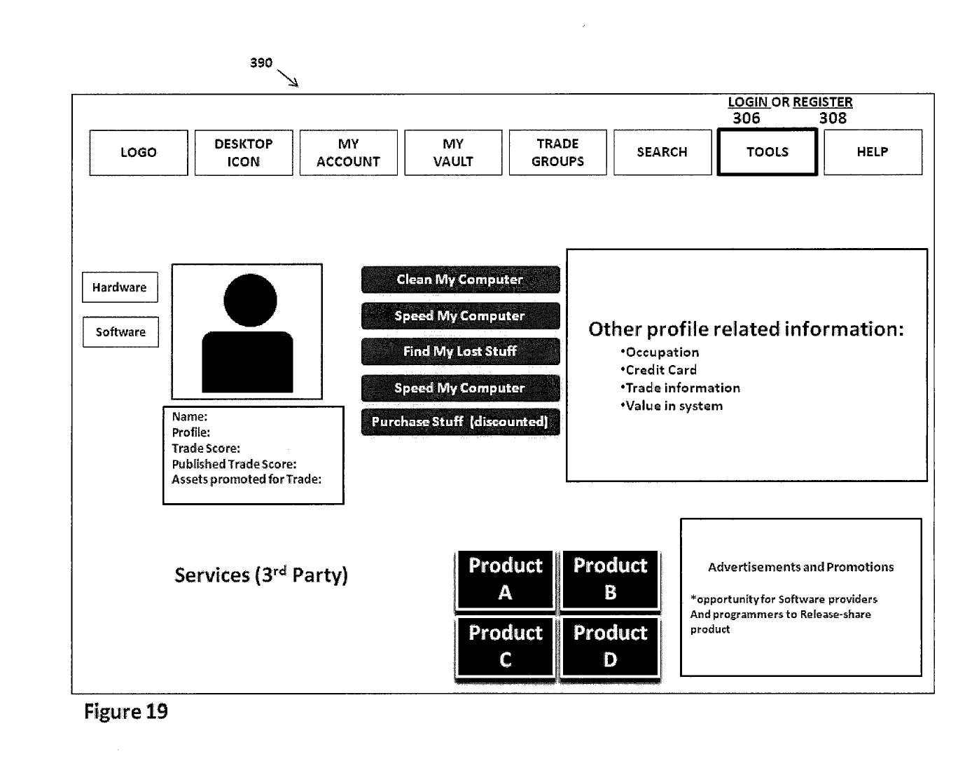

FIG. 19 shows an example of the webpage 390 illustrating other services that a user can access via the portal system to support a transaction.

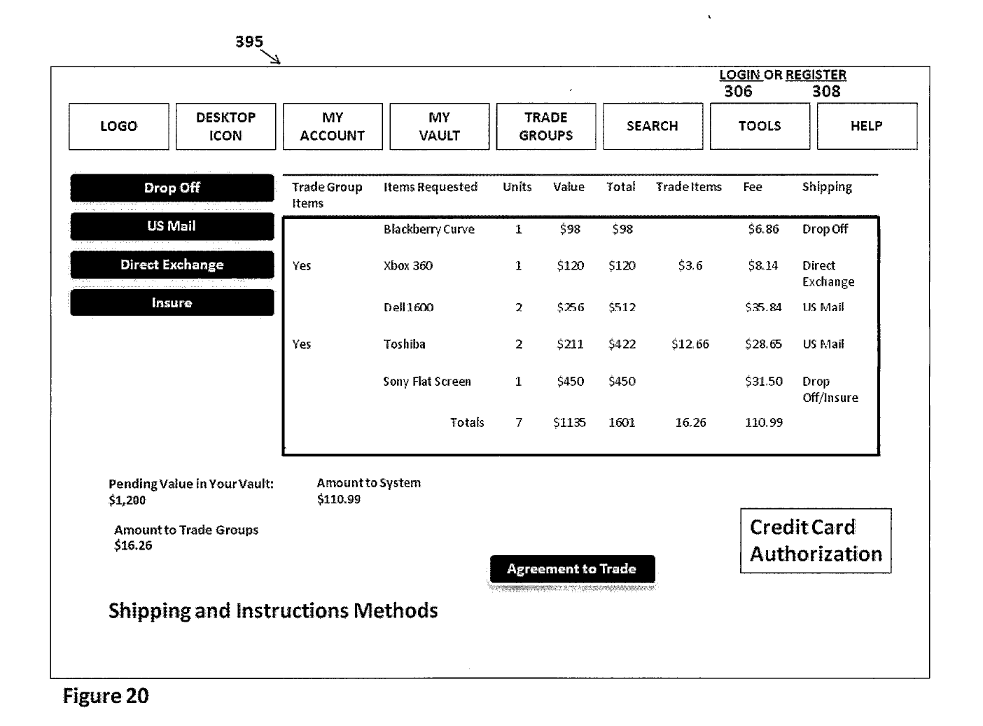

FIG. 20 illustrates an example of web page display 395 of a transaction being processed by the portal system.

### Cashing Out

Referring again to FIG. 3, a user of the system can assign value to a user's used or surplus items, which value can be represented as “barter credits” that are used to trade within system (step 180). Once the system determines this value for a user's inventory of items as previously described (step 181), the user can select options for using this value within the system (step 182), which can include converting value (e.g., for retailer discounts), trading the value to other users, or donating the value to other users (e.g., charitable organizations).

### Forming Trade Groups

The method and system of the invention includes a social network feature that allow users (members) to create or join groups of member, i.e. trade groups, to “pool” assets the members have inventoried in the system based on defined trade group criteria. Trade groups can include members having a common interest in similar items to be traded, or the can include members from the same; city, state or region (Strata). By way of example, a trade group could be used to function as a fund raising program by Allowing schools to create fundraising groups.

Referring again to FIG. 3, a user of the system can form and join trade groups that want to “pool” their inventory assets and receive passive income via their affiliation with the trade group (step 190). To do so, the user can click on the Trade Groups button 326 (see FIG. 8). In response, the system can present the user with a web page that allows the user to send a request to join an existing trade group (step 191) or to form a new trade group. If the user is accepted as a member of a trade group (step 192), he or she can click on the vaults of the other members of that trade group (step 193) and can be presented with options available only to members of the trade group (step 194), such as, for example, the ability to peruse the inventories of other members of the group (step 196).

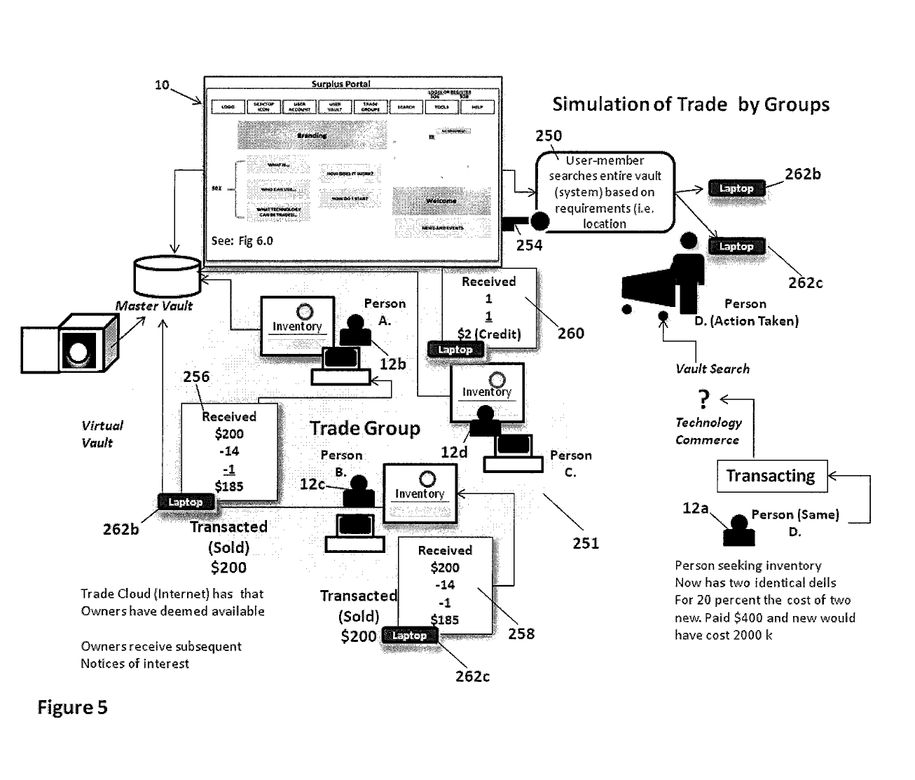

FIG. 5 depicts an example of a fundamental transaction of members in a trade group selling an item from the trade group to a user searching the system. In the example of FIG. 5, an individual user 12a needs two new computers for his company. Because, the user 12a is registered with the portal system 10, he initiates a search (Step 250) to find suitable computers that are available for trade. The system finds two such computers 262b, 262c—one in the vault of another user 12b and one in the vault of user 12c. Both of these users are members of a trade group 251, which also includes user 12d (step 252). Each of the computers 262b, 262c has an assigned value of $200. Using the portal system 10, user 12a can complete transactions (step 254) to purchase these computers for $200 each, for a total of $400 in paid value. To complete the transactions for these computers, the portal system 10 allocates the $400 of received value as follows. From the $200 value received for the computer 262b, the system credits user 12b with $185, with $14 being credited to the system operator 14 as a transaction fee and $1 being credited to the trade group 251. Similarly, from the $200 value received for the computer 262c, the system credits user 12c with $185, with $14 being credited to the system operator 14 as a transaction fee and $1 being credited to the trade group 251. As a result, the trade group receives total credits of $2 (step 260). In this way, members of trade groups can receive credits via their affiliation with the group.

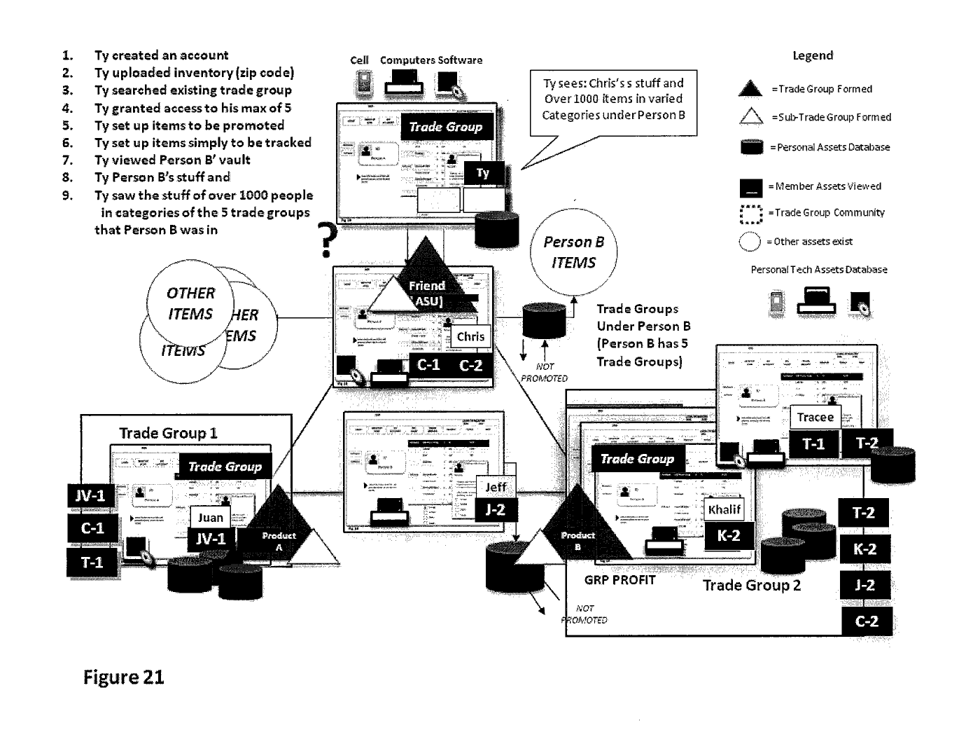

FIG. 21 depicts an example of relationships with one member to many others as it pertains to trade groups. In this depiction there are two trade groups—Product A (represented by Trade Group 1) and Product B (Represented by Trade Group 2).

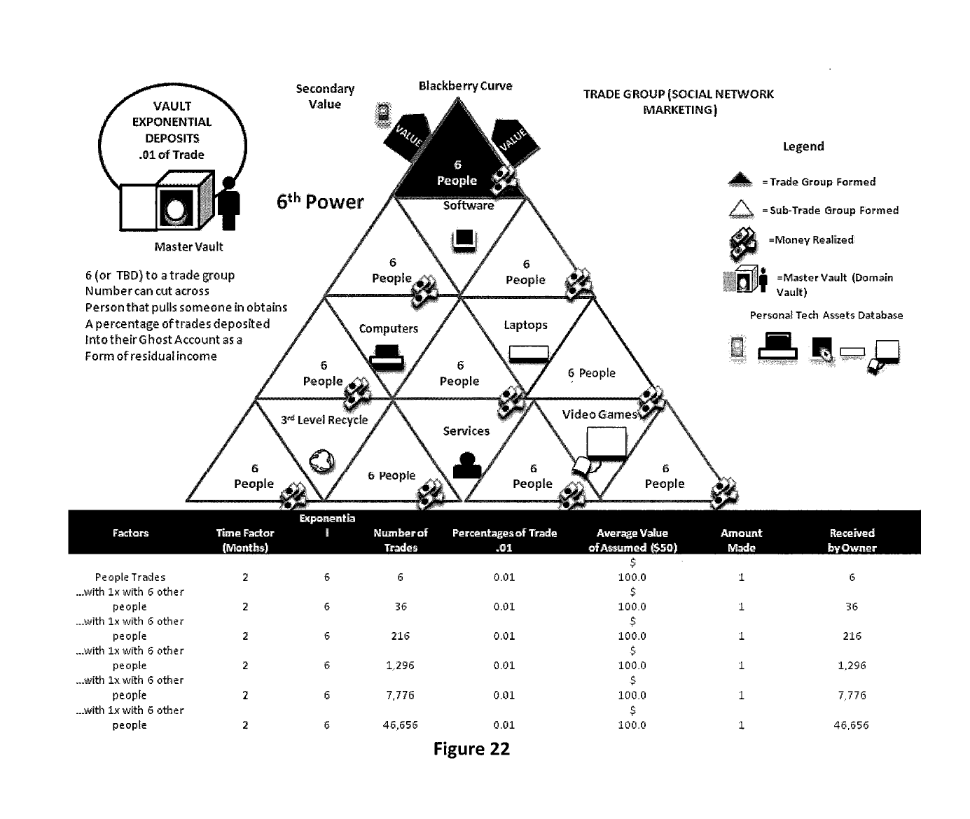

FIG. 22 shows an example of a trade group of six affiliated individuals that will all receive financial benefit when an asset is sold form their group. In this example, the group is formed under a product manager who helps sell goods (or services). The group product manager can responsible for finding opportunity to sell or move product (or services). The total percentage received by the group on a sale is two percent. The lead (or product manager) receives one percent of each sale and the other group members split one percent. In this example, each member within this group must build out a group of six members in order to receive the sum that the lead person receives. Thus, when a product (or service) sells within the group, members to the 6^{th} (or other) power in the relationship can receive a percentage of the revenue made. This example provides for a brokering relationship of uploaded asset. Sharing in a portion of the value or sale of these assets forms a top-down relationship that can generate passive income for upper-level members based on sales made via the online trade group.

According to one aspect of the invention, trade groups can obtain additional members via invites and (or) requests; and receive financial benefit from the chain of relationships established growth in the chain of members and (or affiliates). Trade groups can allow for group member to serve as brokers and judges for new members to form a chain of online brokers who receive benefit for services and brokering of uploaded online assets to other parties.

Having read this disclosure, it will also be understood by those having skill in the art that modifications may be made to the invention without departing from its spirit and scope. Therefore, the invention in its broader aspects is not limited to the specific details, representative devices, and illustrative examples shown and described. Accordingly, departures may be made from such details without departing from the spirit or scope of the general inventive concept.

What is claimed is:

1. A method for online trading of used or surplus items, the method comprising:
using a computer system to prompt a first user of a plurality of users to upload to an online computer system product information regarding a used item;
storing with the computer system the uploaded item in a database of used and surplus items;
prompting with the computer system the first user to assign a trade level to the item, wherein the trade level determines in part whether the uploaded item is available for trade;
calculating with the computer system a value for the uploaded item based on information including one or more of the item type, the item brand, frequency of trades for like items, market demand for the item, survey information obtained from the plurality of users and retail pricing data for like items;
storing with the computer system a value based on the calculated value for the uploaded item;
storing on the computer system a credit amount for the account of a second user;
receiving with the computer system a search request from the second user regarding a desired used or surplus item;
performing with the computer system in response to the second user's search request a search of the database of used and surplus items; and
automatically notifying the second user if the first user's uploaded item matches the second user's search request and is available for trade;
facilitating communications between the first and second user regarding a potential trade of the item;
automatically notifying a third-party service that can provide services to support a trade of the item; and
after receiving notice from the first user and the second user that they have agreed to a transaction for the item, processing the transaction including:
transferring a credit from the account of the second user to an account of the first user based on the calculated value of the uploaded item;
wherein the transferred credit is deducted from a credit amount stored in the account of the second user based on a valuation of used items uploaded by the second user to the online computer system.
